(19) United States
(12) Patent Application Publication
(10) Pub. No.: US 2002/0093529 A1
(43) Pub. Date: Jul. 18, 2002

(54) Method and apparatus to optimize a computing session based on user interaction with a computer

(76) Inventors: Raja Daoud, Santa Clara, CA (US); Thomas Edwin Turicchi JR., Dallas, TX (US)

Correspondence Address: HEWLETT-PACKARD COMPANY, Intellectual Property Administration, P.O. Box 272400, Fort Collins, CO, 80527-2400, US

(21) Appl. No.: 09/764,521

(22) Filed: Jan. 18, 2001

(51) Int. Cl. G06F 13/00; G06F 3/00

(52) U.S. Cl. 345/745; 345/744

(57) ABSTRACT

A method and apparatus for optimizing a computing session for a particular user. The apparatus includes at least one computer readable storage media having an interaction profile, a response policy and computer readable program code stored thereon. User interaction with a computer is monitored and used to generate the interaction profile. The interaction profile includes system data such as the type of platform (e.g., laptop computer), an application ID, and resource availability. The interaction profile also includes user data such as a user ID, a user purpose (e.g., Internet shopping or research) and a user patience level (e.g., time to abort and abort frequency). The interaction profile and the response policy are used to automatically format output for the application and allocate a number of resources.

### FIELD OF THE INVENTION

The invention pertains to a method and an apparatus for monitoring the interaction of a particular user with a computer and generating an interaction profile based thereon, wherein, the interaction profile is used in conjunction with a response policy to optimize a computing session.

### BACKGROUND OF THE INVENTION

The average computer user only waits approximately eight seconds for an Internet hypertext markup language (HTML) page to appear on the screen before moving to another Internet HTML page or an entirely different Internet site altogether. However, while some computer users are impatient and want fast results, others prefer to wait in exchange for a rich interaction including a presentation with extensive graphics, more precise search results, etc. Likewise, each computer user has various functional preferences, such as the type and location of functional buttons. In addition, the preferences of a single user can vary based on the type of Internet site (e.g., shopping, research, browsing), the application (e.g., word processor, spreadsheet, Internet browser), time constraints, the user's mood, the user's computer, etc. Therefore, there is a need to optimize the user's computing session.

One solution is to provide more than one scenario that can be selected by the user. For example, an Internet HTML page or software application may offer the user a choice between 1) a text-only presentation with faster download times and 2) a graphics presentation with longer download times. However, a particular user may not fit into one of these fixed categories and thus may still become discouraged with an Internet site or a software application. For example, where the user selects no graphics for a search, the user may become discouraged during a later shopping session where only product descriptions are displayed as opposed to actual product pictures and may therefore terminate the shopping session before making a purchase. In addition, the user must manually select the type of interaction, generally at the beginning of a session. Where the user wishes to change the selection, the user must manually reconfigure the application or transmit a request to the Internet site to make such a change. In some embodiments, the selection cannot be changed during a session.

Therefore, it is an object of one embodiment of the invention to optimize a computing session for a particular user and to adapt the computing session based on the user's interaction with a computer. It is an object of another embodiment of the invention to automatically format output and allocate resources based on the user's interaction with the computer.

### SUMMARY OF THE INVENTION

In the achievement of the foregoing objects, the inventors have devised a method and apparatus for optimizing a computing session for a particular user and adapting the computing session to changes in the user's interaction with an application. Optimizing the user's computing session might include customizing Internet HTML pages to a particular user so that the user will spend more time at a particular Internet site. Likewise, such optimization might include customizing software applications to a particular user so that the user will feel comfortable and productive with a particular software application and continue to purchase other products and/or upgrades from the same vendor. In addition, optimizing the user's computing session might include managing resource capacity, such as available servers, processors, memory, etc. based on the interaction of a particular user. For example, a software application may allocate more memory to graphics for a user who desires a rich graphics presentation while allocating more memory to processing for a user interested primarily in the functional aspects of an application. Similarly, an Internet service provider (ISP) or Internet vendor may allocate faster servers and/or processors to impatient users, leaving the slower servers for more patient users.

The methods and apparatus may be embodied in software which monitors user interaction with a computer. For example, the software may monitor the type of Internet sites that the user is visiting (e.g., Internet shopping, Internet research), the frequency that the user aborts a query (e.g., queries an alternative Internet site or HTML page), the level of graphics that the user expects, etc. The software uses the monitored interaction, and optionally, also uses system specific information to generate an interaction profile.

The interaction profile may include user data such as a user ID (e.g., User No. 1), a user purpose (e.g., Internet shopping, Internet research) and a user patience level (e.g., time to abort and abort frequency). The interaction profile also preferably includes system data such as the type of platform (e.g., laptop computer, PALM PILOT®), an application ID (e.g., Internet browser, word processor), and resource availability (e.g., video random access memory or VRAM capacity). In addition to the interaction profile, the software also includes a response policy that includes, for example, parameters for formatting output and parameters for allocating resources based on one or more factors included in the interaction profile. For example, where the user purpose is “Internet Shopping” and the user patience level is “nine” on a scale of one to ten, the response policy can specify a high graphics level presentation and allocate additional random access memory (RAM) as dedicated VRAM. Any number of factors can be used in conjunction with any number of parameters to format output and allocate resources based on the interaction of a particular user with a computer. In addition, the interaction profile can be automatically reset (i.e., returning the factors to default values) based on the user switching to another application (e.g., Internet browser to word processor), having a different purpose (Internet shopping to Internet research), at the whim of the user (e.g., desiring a richer graphics presentation), etc. Likewise, the interaction profile can be stored based on a particular platform type, user ID, user purpose, etc. and recalled based on the current platform type, user, purpose, etc.

Thus, one embodiment of the invention optimizes a computing session by automatically formatting output and/or allocating resources based on the users interaction with the computer. Another embodiment of the invention automatically adapts the computing session based on changes in the user's interaction with the computer based on a variety of factors. By automatically optimizing the computing session for the particular user, the user is likely to be more productive and less frustrated when interacting with the computer (e.g., an Internet site or software application). Therefore, the user will tend to spend more time at that Internet site or purchase other software products and/or upgrades from the same vendor.

These and other important advantages and objectives of the present invention will be further explained in, or will become apparent from, the accompanying description, drawings and claims.

### BRIEF DESCRIPTION OF THE DRAWINGS

An illustrative and presently preferred embodiment of the invention is illustrated in the drawings in which:

FIG. 1 is a block diagram of a computer and network system;

FIG. 2 illustrates an interaction profile and a response policy for optimizing a computing session for a particular user;

FIG. 3 is a flow chart showing the steps to optimize the computing session for the particular user;

FIG. 4 illustrates output from an Internet browser application formatted for a particular user;

FIG. 5 illustrates alternative output from the Internet browser application formatted for a particular user; and

FIG. 6 illustrates output from a software application formatted for a particular user.

### DESCRIPTION OF THE PREFERRED EMBODIMENT

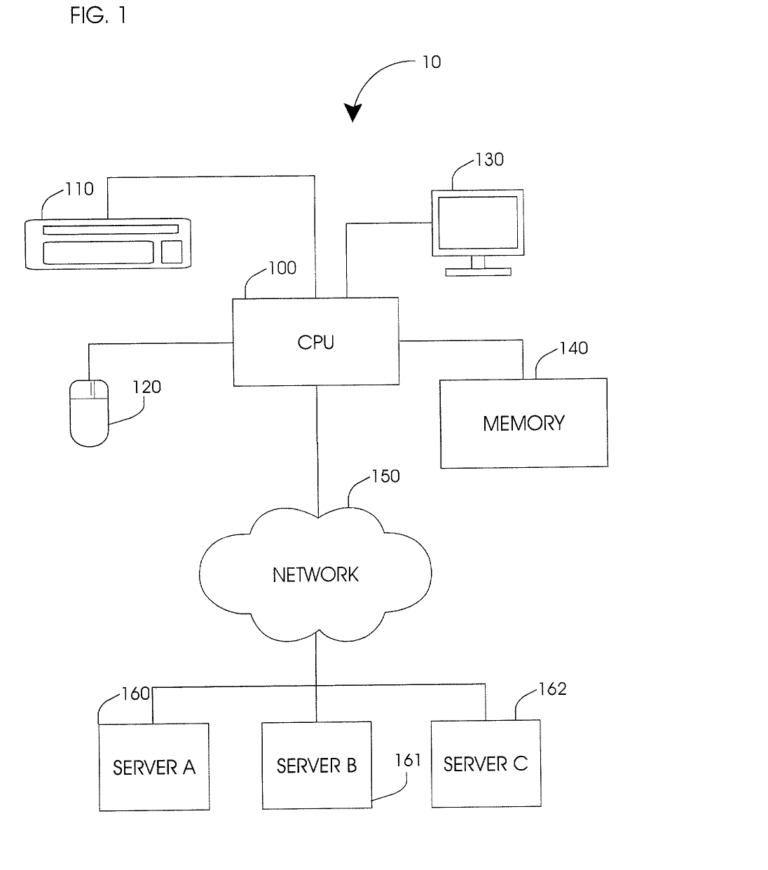

FIG. 1 shows various hardware components of a computer and network system 1 0 over which a computing session can be optimized for a particular user. The computer and network system 10 includes a central processing unit (CPU) 100 or other processor with input devices such as a keyboard 110, mouse 120, output device such as a display 130, and a computer readable storage device or memory 140. Optionally, the CPU 100 can be linked over a network 150 (e.g., a WAN, a LAN, an Intranet, the Internet) to a server 160 or pool of servers 160, 161, 162 (Server A, B, and C).

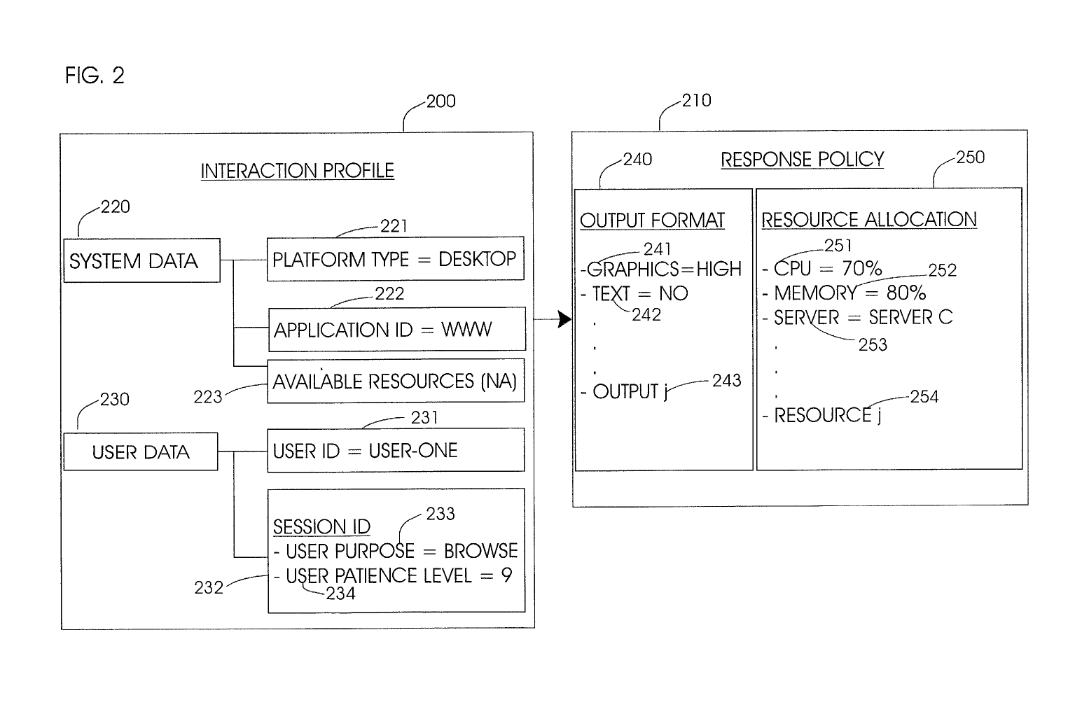

Computer readable program code is provided (e.g., stored in memory 140 and accessed by the CPU 100) for optimizing a computing session (e.g., Internet browsing, word processing) of a particular user. The user's interaction with the application is monitored and used to generate an interaction profile 200 (FIG. 2) that is stored in memory 140. The interaction profile 200 is used in conjunction with a response policy 210 (FIG. 2) to format the output (e.g., on display 130) and/or allocate resources (e.g., the CPU 100, the memory 140, components of the network 150 or of the server 160, etc.). For example, a server 160 serving multiple workstations linked via the network thereto may be configured to give higher priority (i.e., allocate more processing power) to the requests from the workstation of an “impatient user”, as defined by the interaction profile 200. Similarly, the server 160 may be configured to give lower priority (i.e., allocate less processing power) to the requests from the workstation of a “patient user”.

It is understood that the CPU 100 can be any suitable processor such as, but not limited to, an Intel PENTIUM® processor, an entire desktop personal computer (PC), a laptop computer, a PALM PILOT®, an Internet appliance, an application specific integrated circuit (ASIC) manufactured for use with the present invention, etc. Likewise, the memory 140 can be any suitable computer readable storage medium such as read only memory (ROM), random access memory (RAM), video memory (VRAM), hard disk, floppy diskette, zip disk, compact disc (CD), magnetic tape, etc. Further, any number of CPUs 100 (i.e., one or more) and/or any number of memories 140 (i.e., one or more) can be linked to one another either directly or over any suitable network. In such a scenario, the storage of the aforementioned program code can be distributed over the number of memories 140, or executed by various of the number of processors 100. In addition, any suitable peripheral devices (e.g., a printer or scanner) and any suitable input devices (e.g., a touch pad) can be connected to the CPU 100 either directly or indirectly (e.g., over the network 150). Furthermore, the CPU 100 can be linked to the network 150 using any suitable connection (e.g., modem, T-1, digital subscriber line (DSL), infrared, etc.).

The invention can be embodied in firmware or software (i.e., computer readable program code) stored in the computer readable storage media 140 and executed, for example, by the computer processor 100. For example, the invention can be embodied in an applet (i.e., portable code not specific to any particular machine that is stored on a networked server and downloaded and executed/interpreted by the user's computer). The applet can be downloaded from an Internet site (e.g., from server 160, 161, 162) and installed on the user's computer 100 as a plug-in module to the user's existing Internet browser or other application. Alternatively, the software can be integrated with an application such as an Internet browser or word processor, or can even be a stand alone application that optimizes multiple applications and resources used by the user's computer. In yet another embodiment, the invention can be embodied in software that resides on a network server 160, 161, 162 or at an Internet host computer (i.e., an Internet site) and can optimize the computers (e.g., 100) that access the network server 160, 161, 162 or the Internet site. Or the invention can be embodied in software having components that reside both at the user's computer 100 and at one or more locations on the network 150 (e.g., a wide area network or WAN, local area network or LAN, Internet, Intranet, etc.). That is, the invention can be designed to be application-specific, user-specific, computer-specific, site-specific, etc., or a combination thereof.

FIG. 2 illustrates an interaction profile 200 and a response policy 210. The interaction profile 200 can be, for example a database or a multidimensional array stored in memory 140, and includes system data 220 and user data 230. The system data 220 can be gathered independently of the user and includes factors such as platform type 221, application identification (ID) 222, and available resources 223. For example, the platform type 221 can broadly identify the type of platform the application is being operated on, such as a desktop PC or a PALM PILOT®. Or, the platform type 221 can be further categorized to include the speed of the processor 100, the capacity of the memory 140, the resolution of the display 130, an IP address, the user (e.g., an administrator), etc. Also for example, the application identification (ID) 222 can broadly identify the type of application, such as a word processor or Internet browser, or the application can be further categorized to include the software version and vendor (e.g., Corel WORD PERFECT® or Microsoft INTERNET EXPLORER®). Also for example, the available resources 223 can broadly identify whether a particular resource is available, such as indicating whether a server is available or not available. Or, the available resources 223 can be more specific to include the percent CPU utilization, the percent memory available for allocation, etc.

The user data 230 includes factors that are specific to a particular user or class of users. The user data 230 preferably includes a user ID 231 and a session ID 232. The user ID 231 is used to identify a particular user such as an individual, or a class of users (e.g., by department). The session ID 232 is used to identify the purpose of the session, such as Internet shopping. A single user can have more than one session ID 232. For example, the user can have one session ID 232 for Internet shopping, another session ID 232 for Internet research, and yet another session ID 232 for Internet browsing. Likewise, a single user can have more than one user ID (e.g., one for use during employment related matters and another for personal use).

The session ID 232 includes at least a user purpose 233 and a user patience level 234. The user purpose 233 may identify the task that is to be performed using the application, such as Internet research. In a preferred embodiment, the user purpose 233 is determined automatically by the program code. That is, when the user is spending an average of 30 seconds at each HTML page, the program code classifies the user as “generally browsing”, whereas when the user is spending an average of 5 seconds at each HTML page, the program code classifies the user as “searching”. The user purpose 233 can be defined to be more specific or broader than the above examples.

In addition, the user purpose can vary within a single application (e.g., drafting letters or drafting proposals, both using a word processor), or the user purpose can include similar tasks in different applications (e.g., using the “Help” function of a word processor or of a spreadsheet). Such an aspect of the invention is particularly advantageous when the application is a network-delivered application (i.e., executed from the server 160 for use at one or more workstations on the network 150). In such an embodiment, the network resources (e.g., processing by the server 160) can be allocated based on the interaction profile 200 of various users accessing the application via the network. For example, a user that is utilizing many functions of the network-delivered application (e.g., assembling a presentation with video, sound, etc.) can be allocated greater processing capability via the server. Similarly, another user of the same network-delivered application that is merely typing a letter can be allocated minimal processing capability.

The user patience level 234 may be a rank on a scale (e.g., from one to ten), of the user's patience with a task, an application, an Internet site, etc. For example, a user may wait only five seconds for an HTML page containing research topics to load and may therefore be assigned a user patience level 234 of “two” in relation to research. The same user may also wait up to twenty seconds for an HTML page containing news stories and related photos to load, and may therefore be assigned a user patience level 234 of “eight” in relation to browsing. Likewise, a different user may wait for various time periods based on the application, the user's purpose, the platform, the time of day, the user's mood, etc. For example, a user who waits, on average, for ten seconds for an HTML page containing research links may be classified as a very patient user (e.g., assigned a user patience level of “nine”), whereas another user who waits, on average, for any less than ten seconds for the same or similar HTML page may be classified as an impatient user (e.g., assigned a user patience level of “three”). It is understood that any suitable scale can be used to assign a user patience level 234, and the scale can vary based on the application, the user purpose, time of day, traffic on a particular site, etc.

The response policy 210 is also shown in FIG. 2. The response policy is, for example a database or multidimensional array that can be stored in computer readable storage media such as memory 140, and includes output format parameters 240 and resource allocation parameters 250 for the application. The response policy 210 uses one or more of the factors included in the interaction profile to format the output of an application based on the preferences of a particular user and/or to optimally allocate resources for the application. That is, output format 240 may include parameters such as graphics presentation level 241, text presentation level 242, and any number of other output parameters (e.g., Output j 243). Likewise, resource allocation 250 may include parameters such as CPU allocation 251, memory allocation 252, server speed 253, and any number of other allocation parameters (e.g., Resource j 254).

As an example, in FIG. 2, the interaction profile 200 shows that the platform type 221 is “DESKTOP”, the application ID 222 is Internet browsing (i.e., “WWW”), and the user ID 231 is “user one”, while the session ID 232 for the particular user (i.e., user one) indicates that the user purpose 233 is to “browse” and that the user patience level 234 is “high” (i.e., “nine” on a scale of one to ten). Therefore, the response policy 210 shows that the output will be formatted with detailed graphics (i.e., graphics 241 is set to “high”) as opposed to text-only (i.e., text 242 is set to “no”). In addition, the response policy 210 has allocated 70% of the CPU (i.e., at 251), 80% of the memory at 252, and is using the server identified at 253 as “server C” (e.g., server 162 in FIG. 1). As another example (not shown), where the interaction profile 200 might define the user purpose 233 as “email retrieval” and the user patience level 234 as “three” (i.e., again on a scale of one to ten where “ten” is very patient), the response policy may include parameters such as graphics presentation level 241 that is “low” and identify a server 160, 161, 162 at 253 having a “medium” processing speed (e.g., Server B in FIG. 1).

It is understood that the computing session can be optimized by formatting output and/or allocating resources based on the interaction profile 200. In addition, output format 240 can include any number of parameters, such as simple parameters (e.g., no graphics or high graphics), or extensive parameters (e.g., low to high graphics with various degrees therebetween) based on design considerations, such as but not limited to, the content of a particular Internet site. For example, low graphics may be a text presentation with thumbnail images, wherein the user may select a particular thumbnail image to request a larger image thereof (e.g., by clicking with the mouse 120). In this example, an impatient user will receive the requested information faster than where each graphic is transmitted as part of the request. In addition, in this example, where the user begins requesting larger images (i.e., by selecting the thumbnails), the computing session can be automatically optimized by transmitting larger images related to those the user is selecting (e.g., in future sessions, or later during the same session). Or for example, the level of graphics may be based on a file format (e.g., jpeg, bitmap, etc.) or on a file type (e.g., video, still image, etc.). In this example, a patient user may receive high quality graphics, as determined by the file format. Alternatively, an impatient user may receive still images as opposed to video clips, wherein the user can select a video clip based on the still image if the user so desires. Again, as the user becomes more patient or more impatient, the computing session can be optimized accordingly.

In addition, it is understood that each optimization parameter need not be used, and use of various parameters can vary based on the user ID 231, the application ID 222, the platform type 221, etc., or can even be based on externally selected options (e.g., set by the user or an administrator). For example, in FIG. 2 the available resources parameter 223 is not being used (i.e., it has been set to “NA”). Likewise, additional or altogether different parameters than those shown in FIG. 2 can be used to optimize a computing session under the teachings of the present invention. The parameters shown in FIG. 2 are merely illustrative and are not intended to limit the scope of the present invention.

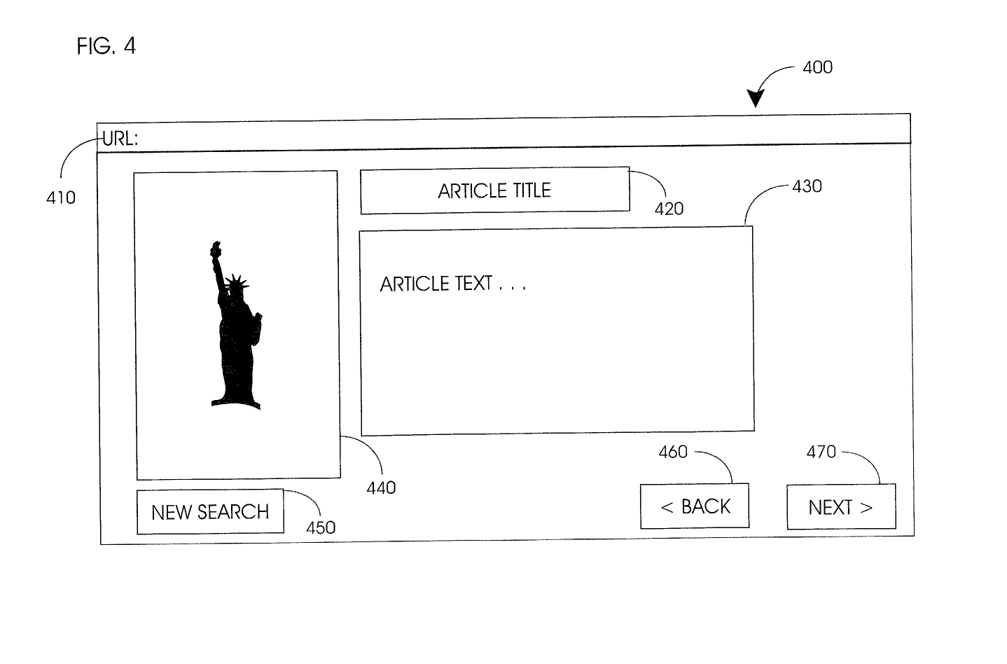

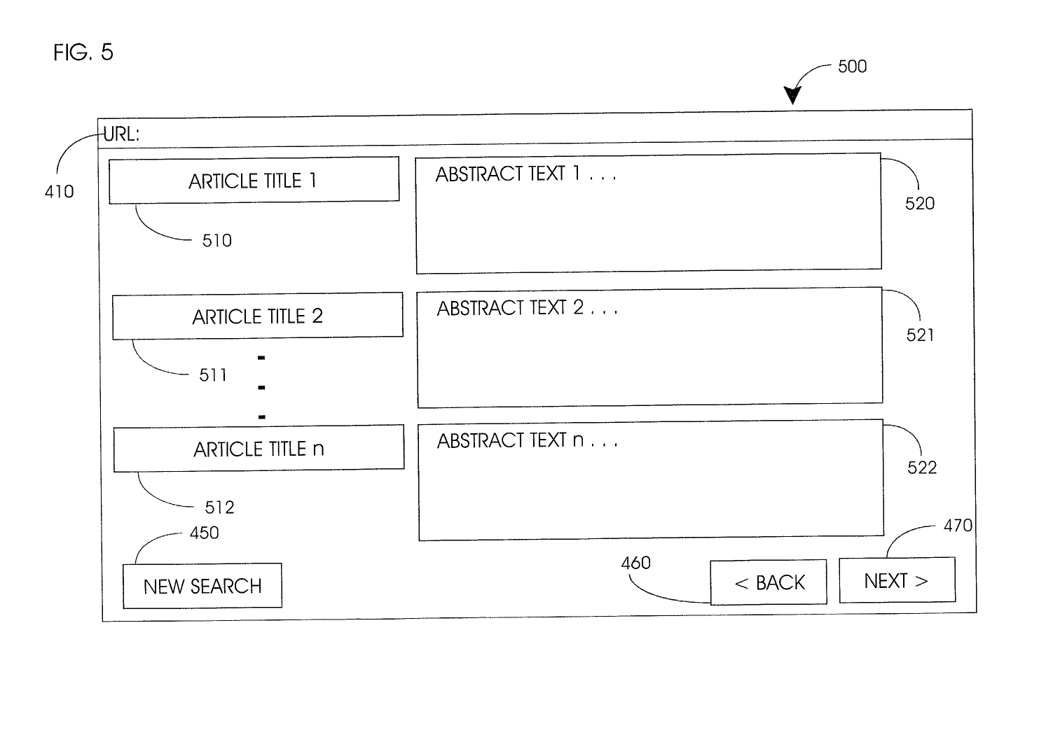

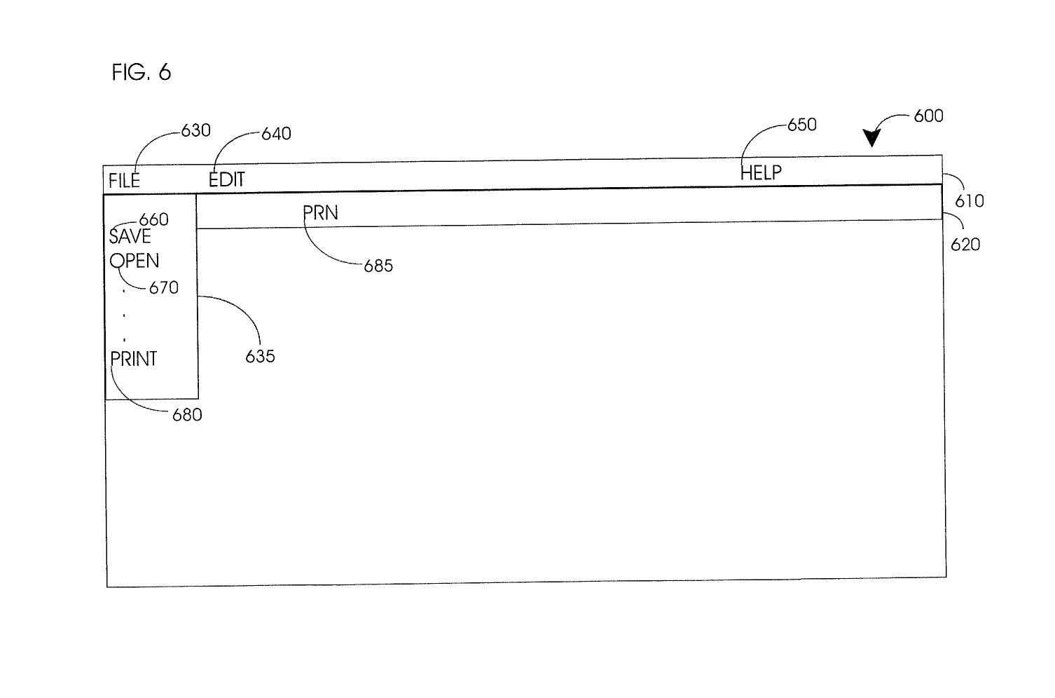

The output can be formatted and/or the resources can be allocated to optimize a computing session in any number of ways. For example, the interaction profile 200 can be used to optimize a “depth-first, drill-down” session. That is, a user may begin such a session by searching the Internet in general, or a specific Internet site by broad category (e.g., printers). As such, the user purpose 233 may indicate that the user is generally researching a topic and thus the response policy 210 can dictate providing short, text-only presentations using high speed servers so that the user can quickly locate a particular subcategory within the broad category. Once the user selects the particular subcategory (e.g., a particular printer brand, printer type, printer manufacturer, etc.), the user purpose 233 can be updated to indicate that the user is now interested in a detailed search and the response policy can dictate detailed graphics and extensive text descriptions, perhaps using a medium speed server (as the user will spend more time reading the displayed HTML page as opposed to making requests from the server). It is understood that any degree of optimization therebetween can also be implemented under the teachings of the present invention. Other examples for optimizing a computing session are discussed in more detail below with respect to FIG. 4, FIG. 5, and FIG. 6. However, the examples given herein are only illustrative of the invention and are not intended to limit the scope of the present invention.

It is also understood that the computing session can be optimized based on parameters stored in memory 140 from a previous computing session that are stored at the workstation or elsewhere on the network (e.g., at server 160). Likewise, the computing session can be optimized based on parameters obtained at the beginning of the computing session, or parameters obtained dynamically during the computing session. That is, measurements for the interaction profile 200 can be taken instantaneously (or on a predetermined basis) and the response policy 210, can be updated to optimize the computing session on a dynamic basis. For example, where a user is browsing the Internet, the user's interaction with the Internet browser can be monitored during a session with a single HTML page at one Internet site, and updated when the user moves to another HTML page at the same Internet site or another Internet site. Or for example, the user's interaction with the Internet browser can be monitored during a session with a single Internet site and updated when the user moves to another Internet site. As further examples, the response policy 210 can be updated each time a menu selection is made, when a file of a certain type is opened, at various times, etc. As yet another example, the response policy 210 can be changed based on the traffic to a particular Internet site. That is, where an Internet site (or server on a network ) is experiencing very little traffic, the output may be extensive and faster servers may be allocated to patient users. Where the Internet site (or server on a network) experiences a period of high traffic, either suddenly or over time, the response policy can be dynamically changed so that the output is medium or low grade (e.g., minimal graphics) and the faster servers are allocated to more impatient users.

In addition, parameters can be measured using any suitable method. For example, the platform type 221 can be determined or ranked by measuring the time an application takes to load after the user clicks on the application icon. Or for example, the user patience level may be determined by measuring the time it takes a user to begin using an application after it has loaded, or the time it takes a user to abort an operation (e.g., moving to another Internet site, or “click” to “click”). An example algorithm for monitoring user interaction and updating the interaction profile 200 follows:

If ABORT<1× per 5 min OR BACK<3× per session, then USER PATIENCE LEVEL=10

If ABORT=5× per 5 min OR BACK<5× per session, then USER PATIENCE LEVEL=5

If ABORT=1× per 10 sec OR BACK>10× per session, then USER PATIENCE LEVEL=0

The response policy 210 would similarly be updated based on the above example algorithm as follows:

If USER PATIENCE LEVEL=10, then GRAPHICS=HIGH and TEXT=NO and SERVER=SERVER A

If USER PATIENCE LEVEL=5, then GRAPHICS=MEDIUM and TEXT=50% and SERVER=SERVER B

If USER PATIENCE LEVEL=0, then GRAPHICS=NONE and TEXT=FULL and SERVER=SERVER C

While the above algorithm is based primarily on the abort frequency (i.e., the number of aborts during a session), the invention also contemplates algorithms based on abort time. That is, the time from which a command is issued until it is aborted can be monitored and used to optimize the session. An exemplary algorithm may include a delivery schedule as follows:

If GRAPHICS=LOW then DELIVERY TIME=2 seconds

If GRAPHICS=MEDIUM then DELIVERY TIME=6 seconds

If GRAPHICS=HIGH then DELIVERY TIME=12 seconds

To illustrate the algorithm, where the average abort time of a particular user is eight seconds, the requested HTML page must be delivered in less than eight seconds to be received by the user before the user aborts the request. Thus, according to the above algorithm, the server 160 is allocated to deliver the requested HTML page using medium graphics.

It is understood that the example algorithms given above are merely illustrative of one embodiment of the invention and are not intended to limit the scope of the invention. Indeed, any suitable algorithm, including those more complex and those simpler than those given above as examples, are contemplated as being within the scope of the invention.

The interaction profile 200 is preferably stored at the user's computer 100 so that time measurements, such as those used to determine the user patience level 234, are least affected by network transport delay (i.e., the delay between when a signal such as an “abort” is sent from the user's computer 100 and when it is received over the network 150). However, it is understood that the interaction profile 200 and the response policy 210 can be stored at the user's computer 100, at the server 160, or anywhere on the network 150. Indeed, various factors of the interaction profile 200 and various parameters of the response policy 210 can be stored at one or more of these locations and accessed as necessary by the different components. For example, a particular user's interaction with various Internet sites can be stored in an interaction profile 200 at the user's computer 100 and a user-specific response policy 210 also stored at the user's computer 100 can be used to format output from each of the various Internet sites. Or for example, individual response policies 210 can be stored at each Internet site and transferred to the user's computer 100 upon the user accessing a particular Internet site so that site-specific output can be customized to a particular user. Alternatively, the response policy 210 can be used at the Internet site and factors from the interaction profile 200 transferred to the Internet site (e.g., using cookies) and each Internet site could use a site-specific response policy to interact with various users based on the user-specific interaction profile 200.

In addition, the factors stored in the interaction profile 200 and the parameters stored in the response policy 210 can be automatically reset (i.e., returned to default values) based on the user switching to another application (e.g., Internet browser to word processor), having a different purpose (Internet shopping to Internet research), at the whim of the user (e.g., desiring a richer graphics presentation), etc. Likewise, the interaction profile can be stored based on a particular platform type, user ID, user purpose, etc. and recalled based on the current platform type, user, purpose, etc. (i.e., many different interaction profiles may be stored).

It is understood that the system data 220 and the user data 230 described above are merely illustrative and not intended to limit the scope of the present invention. Additional or fewer factors and parameters than those described with respect to FIG. 2 can be included in the interaction profile 200 and/or the response policy 210. The factors included in the interaction profile 200 and the parameters in the response policy 210 are design considerations based upon the application, the user, the platform, the degree of optimization or customization desired, etc. Furthermore, the system data 220 and the user data 230 need not be maintained as separate data as shown in FIG. 2 and can be combined, further categorized, stored in different memories 140 at different locations on the network 150, etc.

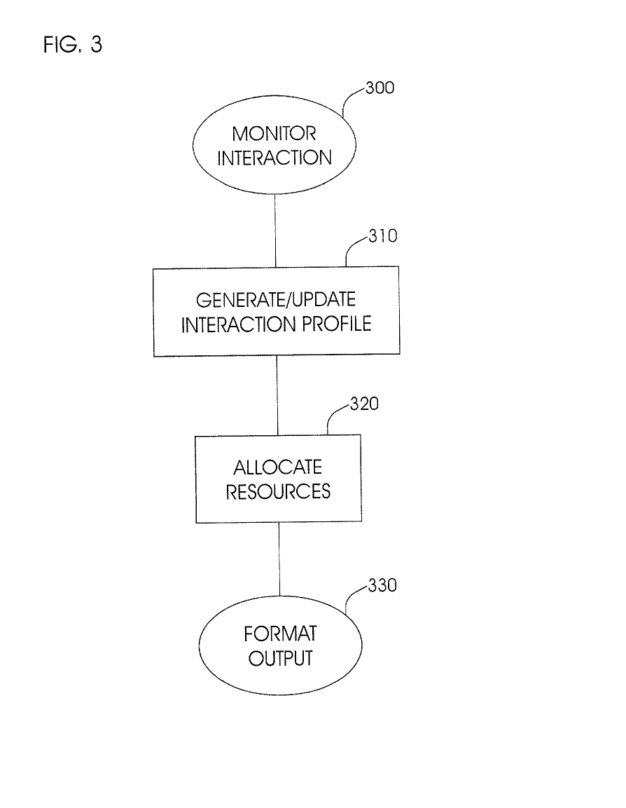

FIG. 3 shows a series of steps to optimize a computing session for a particular user. At step 300, the user's interaction with the application is monitored. That is, input is received at the user's computer 100 (e.g., from keyboard 110, mouse 120) during use of an application, such as the frequency that the user aborts a query at an Internet site, the type of Internet sites that the user is requesting, the time that the user spends at each requested Internet site or at a particular HTML page, etc. In addition, system data 220 that is independent of the user's interaction can also be logged in step 300. In step 310, an interaction profile 200 is generated or updated to include various factors regarding the user's interaction with the application during monitoring in step 300. Optionally, the factors are analyzed. For example, an average or other statistical analysis of the frequency with which the user aborts queries in conjunction with the user's purpose can be used to assign a user patience level 234 that is stored in the interaction profile 200. In step 320, the interaction profile 200 is used in conjunction with the response policy 210 to allocate resources. In step 330, the interaction profile 200 is used in conjunction with the response policy 210 to format output of the application. As an example not intended to limit the scope of the present invention, where multiple users access an Internet retail site, the response policy 210 can: 1) allocate faster servers to the impatient users (i.e., based on user patience level 234), 2) format a requested HTML page as text only for a user connected to the Internet site with a PALM PILOT®, and 3) allocate medium speed servers and format a requested HTML page to include a high quality graphics presentation for a patient user connected to the Internet site using a desktop PC with a DSL connection.

It is understood that the steps of the method described above with respect to FIG. 3 can be performed at a single workstation or at multiple components on the network 150. For example, steps 310 and 320 may occur at the workstation, while steps 330 and 340 occur at the server 160. Or for example, each of the steps 310 through 340 can occur at the workstation 160. Likewise, other embodiments may include additional steps to those shown in FIG. 3. For example, where the interaction profile 200 is stored at the workstation, an additional step may include transmitting the interaction profile 200 to the server 160.

It is also understood that the computer readable program code can be conventionally programmed using any suitable computer readable programming language (e.g., a JAVA applet, a CGI script in Perl, a compiled C language program, an application developed using ORACLE, BLUESTONE, or BROADVISION platforms, etc.), and can include one or more functions, routines, subfunctions, and subroutines, and need not be combined in a single software package.

It is also to be understood that the steps shown in FIG. 3 need not be performed in the order shown. For example, allocating resources in step 320 can occur after or simultaneously with formatting output in step 330. Likewise, the invention also contemplates methods including fewer steps and methods including additional steps than those shown in FIG. 3. For example, in one embodiment, the response policy 210 can specify only formatting output (step 330) and omit allocating resources (step 320), or vice versa.

FIG. 4 through FIG. 6 are illustrative of output formatted for the various applications based at least in part on the interaction profile 200 and the response policy 210. FIG. 4 is an example of output 400 (e.g., a news article) on display 130 for an application such as an Internet browser configured using the interaction profile 200 and the response policy 210. In this example, the user patience level 234 is high (i.e., the user does not frequently abort queries by entering new URLs 410 before the HTML page is fully displayed). Therefore, the output 400 is a rich presentation including the title of the article 420, the full text of the article 430, and a graphic 440. In addition, frequently used buttons, such as the “new search” button 450, the “back” button 460, and the “next” button 470, are also shown. As a further example, the interaction profile 200 can include user data 230 indicating that the user is likely to return to the HTML pages recently viewed (e.g., using the “back” button 460). Therefore, the response policy 210 can dictate retaining the previous five HTML pages in RAM (i.e., under memory allocation 252).

FIG. 5 is an example of output 500 (e.g., search results) on display 130 for an application such as an Internet browser configured using the interaction profile 200 and the response policy 210. In this example, the user patience level 234 is low (i.e., the user frequently aborts queries by entering new URLs 410 before the HTML page is fully displayed). Therefore, the output 500 is a minimal text presentation including multiple article titles 510-512 and the corresponding abstracts 520-522.

FIG. 6 is an example of output 600 (e.g., a menu bar 610 and a tool bar 620) on display 130 for an application such as a word processor configured using the interaction profile 200 and the response policy 210. In this example, the conventional menu selections such as the “file” selection 630, the “Edit” selection 640, and the “Help” selection 650 are displayed on the menu bar 610. When the user chooses (e.g., “clicks on”) the “Help” selection 650, the search results can be formatted according to the response policy 210 based on the interaction profile 200. As an example, the “Help” function can return narrow search results where prior interactions (i.e., the user data 230) indicate that the user prefers to be directed to very precise answers in response to a search query. Or, the “Help” function can return extensive search results where prior interactions (i.e., the user data 230) indicate that the user prefers to review other areas related to the search query.

A customized toolbar 620 is also shown in the example output 600 of FIG. 6. The user can expand the “File” selection 630, revealing any number of menu options 635 such as the “Save” option 660, the “Open” option 670, and the “Print” option 680. In this example, the interaction profile 200 (i.e., the user data 230) indicates that the user frequently selects the “Print” option. As a result, the response policy 210 dictates that a shortcut button (i.e., “PRN” button 685) be displayed on the toolbar 620. As such, the user can now readily access the print function without having to first select “File” 630, and then move the cursor down to the “Print” option 680.

It is to be expressly understood that the output illustrated in FIG. 4 through FIG. 6 is merely exemplary and not intended to limit the scope of the invention. For example, various degrees of output can be included in the response policy 210 based on any number of parameters included in the interaction profile 200. Other embodiments contemplated as within the scope of this invention will also occur to those skilled in the art.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for optimizing a computing session for a particular user, comprising:
monitoring user interaction with a computer during said computing session;
generating an interaction profile based on said monitored user interaction; and
optimizing said computing session based at least in part on said generated interaction profile and on a response policy.

2. The method of claim 1, wherein generating the interaction profile comprises:
assigning a user patience level; and
identifying a user purpose.

3. The method of claim 2, wherein said user patience level is assigned in response to monitoring user abort time and user abort frequency.

4. The method of claim 2, wherein said user purpose is identified by monitoring user queries and measuring a time between said monitored user queries.

5. The method of claim 1, wherein generating said interaction profile comprises gathering system data including a user platform type, available resources, and an identification of an application which is in use.

6. The method of claim 1, wherein optimizing said computing session comprises allocating a number of resources based at least in part on said generated interaction profile and on said response policy.

7. The method of claim 1, wherein optimizing said computing session comprises formatting output for an application based at least in part on said generated interaction profile and on said response policy.

8. An apparatus for optimizing a computing session for a particular user, comprising:
at least one computer readable storage media;
computer readable program code stored on said at least one computer readable storage media, said computer readable program code comprising:
a. program code for generating an interaction profile and a response policy;
b. program code for monitoring user interaction with a computer;
c. program code for updating said interaction profile based on said user interaction; and
d. program code for optimizing said computing session based at least in part on said interaction profile and on said response policy.

9. The apparatus of claim 8, wherein said program code for optimizing said computing session comprises program code for allocating a number of resources based at least in part on said interaction profile and on said response policy.

10. The apparatus of claim 8, wherein said program code for optimizing said computing session comprises program code for formatting output, said program code for formatting output dictating a level of display detail.

11. The apparatus of claim 8, wherein said interaction profile includes system data and user data.

12. The apparatus of claim 11, wherein said user data includes at least a user purpose and a user patience level.

13. The apparatus of claim 11, wherein said system data includes at least a platform type, an application ID, and resource availability.

14. The apparatus of claim 8, wherein said program code is an applet.

15. The apparatus of claim 8, wherein said user interaction is through an Internet browser.

16. An apparatus for optimizing a computing session for a particular user, comprising:
means for monitoring user interaction with a computer;
means for generating an interaction profile based on said user interaction; and
means for optimizing said user interaction based at least in part based on said interaction profile.

17. The apparatus of claim 16, wherein said optimizing means further comprises means for formatting output of said application.

18. The apparatus of claim 16, wherein said optimizing means further comprises means for allocating a number of resources based at least in part on said interaction profile.

19. The apparatus of claim 18, wherein said number of resources are allocated to optimize delivery time of content for said particular user.

20. The apparatus of claim 16, wherein said means for generating further comprises:
means for assigning a user patience level;
means for identifying a user purpose;
means for creating a session ID based on said assigned user patience level and on said identified user purpose.
